(19) United States
(12) Patent Application Publication
(10) Pub. No.: US 2009/0185967 A1
(43) Pub. Date: Jul. 23, 2009

(54) Composition based on zirconium, cerium and tin oxides, preparation and use as catalyst

(76) Inventors: Alain Demourgues, Pessac (FR); Stephan Verdier, Rueil-Malmaison (FR)

Correspondence Address: BUCHANAN, INGERSOLL & ROONEY PC, POST OFFICE BOX 1404, ALEXANDRIA, VA, 22313-1404, US

(21) Appl. No.: 10/592,927

(22) PCT Filed: Mar. 11, 2005
(86) PCT No.: PCT/FR2005/000593

§ 371 Date: Sep. 9, 2008

(30) Foreign Application Priority Data
Mar. 17, 2004 (FR) 040750

(51) Int. Cl. B01J 23/10; B01D 53/94; B01D 53/54; B01D 53/56; B01D 53/66; B01D 53/48; B01D 53/72

(52) U.S. Cl. 423/213.2; 502/304; 502/303; 423/236; 423/239.1; 423/219; 423/244.06; 423/245.3; 502/182

(57) ABSTRACT

The invention concerns a composition based on zirconium oxide and cerium oxide and, optionally, an oxide of another rare earth, characterized in that it contains tin oxide in a proportion of more than 25 wt. % of oxide. Said composition is obtained by a method which consists in forming a mixture comprising zirconium, cerium and tin compounds and, optionally a compound of another rare earth; in bringing said mixture in the presence of a basic compound whereby a precipitate is obtained; heating said precipitate in an aqueous medium and calcining same. The composition can be used as catalyst, in particular for treating motor vehicle exhaust gases.

The present invention relates to a composition based on zirconium, cerium and tin oxides, to its preparation and to its use as catalyst.

“Multifunctional” catalysts are currently used for the treatment of exhaust gases from internal combustion engines (automobile afterburning catalysis). The term “multifunctional” is understood to mean catalysts capable of carrying out not only oxidation, in particular of carbon monoxide and hydrocarbons present in exhaust gases, but also reduction, in particular of nitrogen oxides also present in these gases (“three-way” catalysts). Zirconium oxide and cerium oxide today appear as two constituents which are particularly important and advantageous for this type of catalyst.

To be effective, these catalysts have to exhibit a satisfactory specific surface, even at high temperature.

Another quality required for these catalysts is reducibility. The term “reducibility” is understood to mean, here and for the remainder of the description, the ability of the catalyst to be reduced in a reducing atmosphere and to be reoxidized in an oxidizing atmosphere. This reducibility can be measured by the ability to capture hydrogen. It is due to the cerium in the case of the compositions of the known type, cerium having the ability to be reduced or to be oxidized. This reducibility and consequently the efficiency of the catalyst are at a maximum at a temperature which is currently fairly high for the known catalysts. This temperature is generally of the order of 600° C. In point of fact, there exists a need for catalysts for which this temperature is lowered or, more generally still, for which, at a given lower temperature, the reducibility is increased.

The subject matter of the invention is thus the development of a catalyst possessing improved reducibility at low temperature.

With this aim, the composition of the invention is based on zirconium oxide and on cerium oxide and it is characterized in that it comprises tin oxide in a proportion of at most 25% by weight of oxide.

Other characteristics, details and advantages of the invention will become even more fully apparent on reading the description which will follow and concrete but nonlimiting examples intended to illustrate it.

In the continuation of the description, the term “specific surface” is understood to mean the BET specific surface determined by nitrogen adsorption in accordance with standard ASTM D 3663-78 laid down from the Brunauer-Emmett-Teller method described in the periodical “The Journal of the American Chemical Society, 60, 309 (1938)”.

The term “rare earth metal” is understood to mean yttrium and the elements from the group consisting of the elements of the Periodic Table with an atomic number of between 57 and 71 inclusive.

It is specified that, in the continuation of the description, unless otherwise indicated, the values at the limits are included in the ranges of values which are given.

The contents are given as oxides, unless otherwise indicated. The cerium oxide is in the form of ceric oxide (CeO₂). The tin oxide is in the form of stannic oxide (SnO₂).

The compositions of the invention are provided according to two embodiments which differ in the nature of their base constituents, other than the tin.

According to the first embodiment, these compositions are based on zirconium oxide and on cerium oxide. In this case, the composition does not comprise other oxides of another element which can be a constituent element of this composition and/or a stabilizer of the surface of the latter in the form of a rare earth metal other than cerium.

In the case of the second embodiment of the invention, the compositions are based on cerium oxide, on zirconium oxide and they additionally comprise at least one oxide of a rare earth metal other than cerium. In this case, compositions are thus involved which comprise, in addition to the tin oxide, at least three and optionally four other oxides, indeed even more. The rare earth metal other than cerium can be chosen in particular from yttrium, lanthanum, neodymium and praseodymium, lanthanum and neodymium being preferred.

Still in the case of this second embodiment, the content, expressed as weight of the oxide of the rare earth metal other than cerium with respect to the weight of the whole of the composition, is generally at most 35%, in particular at most 15%, more particularly at most 10%. The compositions for which the contents of rare earth metal other than cerium are the highest are preferably those for which at least one of these rare earth metals other than cerium is praseodymium.

The respective proportions of zirconium oxide and of cerium oxide can vary within a wide range, whatever the embodiment. Preferably, these proportions are such that the Ce/Zr molar ratio is between 0.10 and 4., more particularly between 0.15 and 2.25 and more particularly still between 0.2 and 1.20.

The main characteristic of the compositions of the invention is the presence of tin oxide. The content of this oxide, expressed as weight of oxide (SnO₂) with respect to the weight of the whole of the composition, is at most 25%. This content is more particularly at most 20%. It can be at most 10% and more particularly still at most 5%.

The minimum content of tin is that below which an effect on the reducibility of the composition is no longer observed. This effect, as will be seen later, can be reflected by the presence of a reducibility peak at a relatively low temperature of less than 500° C. Generally, this tin content is at least 0.5%, more particularly at least 1%.

The compositions of the invention can optionally be provided in the form of a pure solid solution. The nature of this solid solution varies according to the Ce/Zr ratio. More specifically, in the case of a Ce/Zr ratio of less than 1, compositions are then involved in which the cerium, the tin and, if appropriate, the other rare earth element are present completely in solid solution in the zirconium. The X-ray diffraction spectra of these compositions reveal in particular, within the latter, the existence of a single clearly identifiable phase corresponding to that of a zirconium oxide crystallized in the tetragonal system with an offset in the unit cell parameters, thus reflecting the incorporation of the cerium, of the tin and of the other element in the crystal lattice of the zirconium oxide and thus the production of a true solid solution. In the case of a Ce/Zr ratio of greater than 1, the X-ray diffraction spectra of these compositions then reveal, within the latter, the existence of a single pure or homogeneous phase which corresponds in fact to a crystalline structure of the fluorine type, just like crystalline ceric oxide CeO₂, the unit cell parameters of which are more or less offset with respect to a pure cerium oxide, thus reflecting the incorporation of the zirconium, of the tin and, if appropriate, of the other rare earth metal in the crystal lattice of the cerium oxide and thus, here again, the production of a true solid solution.

This solid solution can be retained in compositions having undergone calcinations up to a temperature of 1000° C. for 10 hours. For the compositions according to the second embodiment and exhibiting a Ce/Zr ratio of less than 1, the solid solution can even be retained up to calcination at 1100° C., 10 hours.

The compositions of the invention have specific reducibility properties.

The reducibility of the compositions is determined by the measurement of their ability to capture hydrogen as a function of the temperature. A maximum reducibility temperature, which corresponds to the temperature at which the capture of the hydrogen is at a maximum and where, in other words, the reduction of the cerium(IV) to give cerium(III) is also at a maximum, is also determined by this measurement.

The reducibility of the compositions of the invention can also be measured by their oxygen storage capacity in dynamic mode (dynamic-OSC).

In the case of the present invention, this dynamic-OSC is demonstrated by a test which measures the ability of the compositions to store oxygen in an oxidizing medium and to restore it in a reducing medium. The test evaluates the ability of the compositions to successively oxidize a certain injected amount of carbon monoxide with oxygen and to consume a certain injected amount of oxygen in order to reoxidize the composition. The method employed is described as dynamic as the streams of carbon monoxide and of oxygen are alternated at a frequency of 1 Hz (one injection for 1 second).

In the case of the first embodiment, the compositions of the invention exhibit an OSC at 400° C. of at least 0.3 ml of O₂/g/s. This OSC value and all those given in the present description apply to products which have been calcined at 1000° C. for 10 hours. This OSC can be at least 0.4 ml of O₂/g/s, still at 400° C. This value can be at least 0.9 ml of O₂/g/s, in particular for the compositions in which the Ce/Zr ratio is at least 0.5.

Furthermore, according to an advantageous characteristic, the compositions of the first embodiment can also exhibit a not insignificant OSC at a lower temperature. Thus, more specifically, this OSC at 300° C. can be at least 0.1 ml of O₂/g/s, more particularly at least 0.2 ml of O₂/g/s, in the case of the compositions in which the Ce/Zr ratio is at least 0.5.

For the compositions according to the second embodiment, the compositions exhibit an OSC at 400° C. of at least 0.35 ml of O₂/g/s. For the compositions in which the rare earth metal other than cerium is not yttrium, this OSC can optionally be at least 1 ml of O₂/g/s, more particularly at least 1.5 ml of O₂/g/s and more particularly still at least 2 ml of O₂/g/s; values of at least approximately 2.6 ml of O₂/g/s can be obtained.

The compositions in which the rare earth metal other than cerium is not yttrium themselves also exhibit the advantageous characteristic of having a degree of OSC at 300° C. for which the value can be at least 0.2 ml of O₂/g/s, more particularly at least 0.4 ml of O₂/g/s.

The reducibility properties of the compositions of the invention can also be reflected by the presence of at least one reducibility peak at a temperature of less than 500° C.

The presence of this peak appears in the curves measuring the amount of hydrogen captured as a function of the temperature which are obtained by the method of measuring hydrogen capture described above. In the case of the compositions of the invention, these curves show at least one peak at a temperature of less than 500° C. In the preferred alternative forms of the invention, in particular in the case of the compositions according to the second embodiment, this peak also corresponds to a maximum of capture for the curve and is referred to as maximum peak in the present description.

More particularly, this peak, whether maximum or not, corresponds to a temperature value of less than 400° C.

The presence of at least one peak at a temperature of less than 500° C. clearly demonstrates, for the compositions of the invention, that there is a not insignificant reduction activity which begins at a temperature of less than 500° C.

The compositions of the invention exhibit a still significant specific surface even at a high calcination temperature, the value of this surface varying according to the embodiment and according to the value of the Ce/Zr ratio.

In the case of the first embodiment and for a Ce/Zr ratio of at least 1, this specific surface, after calcination at 1000° C. for 10 hours, is at least 5 m²/g. For a Ce/Zr ratio of less than 1, this surface is at least 8 m²/g, preferably at least 10 m²/g, and values of at least approximately 16 m²/g can be obtained.

In the case of the second embodiment and for a Ce/Zr ratio of at least 1, this specific surface, after calcination at 1000° C. for 10 hours, is at least 5 m²/g, preferably at least 10 m²/g, and values of at least approximately 16 m²/g can be obtained. For a Ce/Zr ratio of less than 1, this surface is at least 15 m²/g, preferably at least 20 m²/g and more preferably still at least 30 m²/g, and values of at least approximately 47 m²/g can be obtained.

After calcination at 1100° C. for 10 hours, this surface can be at least 4 m²/g and more particularly at least 10 m²/g for the compositions of the second embodiment in which the rare earth metal other than cerium is not yttrium.

The process for the preparation of the compositions of the invention will now be described.

This process is characterized in that it comprises the following stages:

(a) a mixture comprising compounds of zirconium, of cerium, of tin and, if appropriate, of the abovementioned rare earth metal is formed;

(b) said mixture is brought into contact with a basic compound, whereby a precipitate is obtained;

(c) said precipitate is heated in an aqueous medium;

(d) the precipitate thus obtained is calcined.

The first stage of the process thus consists in preparing a mixture of a zirconium compound, of a cerium compound, of a tin compound and optionally of at least one compound of the additional rare earth metal.

The mixture is generally prepared in a liquid medium, which is preferably water.

The compounds are preferably soluble compounds. They can in particular be zirconium, cerium, tin and rare earth metal salts. These compounds can be chosen in particular from nitrates, sulfates, acetates, chlorides, ceric ammonium nitrates.

Mention may thus be made, as examples, of zirconium sulfate, zirconyl nitrate or zirconyl chloride. Use is most generally made of zirconyl nitrate. Mention may also be made in particular of cerium(IV) salts, such as nitrates or ceric ammonium nitrates, for example, which are particularly well suited here. Ceric nitrate can be used. It is advantageous to use salts with a purity of 99.5% and more particularly of at least 99.9%. An aqueous ceric nitrate solution can, for example, be obtained by reaction of nitric acid with a ceric oxide hydrate prepared conventionally by reaction of a solution of a cerous salt, for example cerous nitrate, and of an aqueous ammonia solution in the presence of aqueous hydrogen peroxide solution. Use may also in particular be made of a ceric nitrate solution obtained according to the process for the electrolytic oxidation of a cerous nitrate solution, such as disclosed in the document FR-A-2 570 087, which in this instance constitutes an advantageous starting material.

It should be noted here that the aqueous solutions of cerium salts and of zirconyl salts can exhibit a degree of initial free acidity which can be adjusted by addition of a base or of an acid. However, it is just as possible to employ an initial solution of cerium and zirconium salts effectively exhibiting a degree of free acidity as mentioned above as solutions which will have been neutralized beforehand more or less exhaustively.

This neutralization can be carried out by addition of a basic compound to the abovementioned mixture so as to limit this acidity. This basic compound can, for example, be an aqueous ammonia solution or alternatively a solution of alkali metal (sodium, potassium, and the like) hydroxides but preferably an aqueous ammonia solution.

It is also possible to use a sol as starting zirconium or cerium compound. The term “sol” denotes any system composed of fine solid particles of colloidal dimensions, that is to say dimensions of between approximately 1 nm and approximately 500 nm, based on a zirconium or cerium compound, this compound generally being a zirconium or cerium oxide and/or oxide hydrate, in suspension in an aqueous liquid phase, it being possible in addition for said particles optionally to comprise residual amounts of bonded or adsorbed ions, such as, for example, nitrates, acetates, chlorides or ammoniums. It should be noted that, in such a sol, the zirconium or the cerium may be found either entirely in the form of colloids or simultaneously in the form of ions and in the form of colloids.

For the tin compound, use may be made of tin salts, such as halides, carboxylates, in particular acetates, oxalates, tartrates, ethylhexanoates or acetylacetonates, sulfates and organotin compounds, such as mono- di- or trialkyltin oxides or chlorides, in particular the methyls and ethyls. Use is made in particular of the halides and in particular of the chloride. The tin chloride is most generally used in the form of a hydrated salt. However, carboxylates and more particularly oxalates may be preferred insofar as they reduce the risk of pollution by halides. Use may in particular be made of a salt or a solution of tin in the (IV) oxidation state but the use of tin in the (II) oxidation state is also possible.

Finally, it should be noted that, when the starting mixture comprises a cerium compound in which the latter is in the form of Ce(III) and/or a tin compound in which the latter is in the Sn(II) form, it is preferable to involve an oxidizing agent, for example aqueous hydrogen peroxide solution, in the course of the process. This oxidizing agent can be used by being added to the reaction medium during stage (a) or during stage (b), in particular at the end of the latter.

The mixture can be obtained without distinction either from compounds initially in the solid state which will be subsequently introduced into an aqueous vessel heel, for example, or alternatively directly from solutions of these compounds and then mixing said solutions in any order.

In the second stage of the process, the mixture obtained in stage (a) is brought into contact with a basic compound. Products of the hydroxide type can be used as base or basic compound. Mention may be made of alkali metal or alkaline earth metal hydroxides. Use may also be made of secondary, tertiary or quaternary amines. However, amines and aqueous ammonia may be preferred insofar as they reduce the risk of pollution by alkali metal or alkaline earth metal cations. Mention may also be made of urea. The basic compound is generally used in the form of an aqueous solution.

The way in which the mixture and the solution are brought into contact, that is to say the order of introduction of these, is not critical. However, this contacting operation can be carried out by introducing the mixture into the solution of the basic compound. This alternative form is preferable in order to obtain the compositions in the form of solid solutions.

The contacting operation or the reaction between the mixture and the solution, in particular the addition of the mixture to the solution of the basic compound, can be carried out all at once, gradually or continuously, and it is preferably carried out with stirring. It is preferably carried out at ambient temperature.

The following stage of the process is the stage of heating the precipitate in an aqueous medium.

This heating can be carried out directly on the reaction medium obtained after reaction with the basic compound or on a suspension obtained after separation of the precipitate from the reaction medium, optional washing and resuspending in water of the precipitate. The temperature at which the medium is heated is at least 100° C. and more particularly still at least 130° C. The heating operation can be carried out by introducing the liquid medium into an enclosed space (closed reactor of the autoclave type). Under the temperature conditions given above, and in an aqueous medium, it may be specified, by way of illustration, that the pressure in the closed reactor can vary between a value of greater than 1 bar (10⁵ Pa) and 165 bar (1.65×10⁷ Pa), preferably between 5 bar (5×10⁵ Pa) and 165 bar (1.65×10⁷ Pa). The heating can also be carried out in an open reactor for temperatures in the region of 100° C.

The heating can be carried out either under air or under an inert gas atmosphere, preferably nitrogen.

The duration of the heating can vary within wide limits, for example between 1 and 48 hours, preferably between 2 and 24 hours.

The medium subjected to the heating preferably exhibits a basic pH, that is to say that it is greater than 7 and more particularly at least 10.

It is possible to carry out several heating operations. Thus, the precipitate obtained after the heating stage and optionally a washing operation can be resuspended in water and then another heating operation can be carried out on the medium thus obtained. This other heating operation is carried out under the same conditions as those which have been described for the first.

The product obtained on conclusion of stage (c) can optionally be washed and/or dried, for example by passing through an oven.

The final stage of the process is a calcination stage.

This calcination makes it possible to develop the crystallinity of the product obtained and it can also be adjusted and/or chosen according to the subsequent operating temperature reserved for the composition according to the invention, this being done while taking into account the fact that the specific surface of the product becomes smaller as the calcination temperature employed becomes higher.

The process of the invention can be carried out according to an alternative form which will now be described.

The process according to this alternative form comprises an additional stage, intermediate between the heating stage (c) and the calcination stage (d).

This additional stage consists in adding, to the precipitate resulting from the above heating stage (c), an additive which is chosen from anionic surfactants, nonionic surfactants, polyethylene glycols and carboxylic acids and their salts and surfactants of the carboxymethylated ethoxylates of fatty alcohols type.

As regards this additive, reference may be made to the teaching of application WO 98/45212 and use may be made of the surfactants disclosed in this document.

Mention may be made, as surfactants of the anionic type, of ethoxycarboxylates, ethoxylated fatty acids, sarcosinates, phosphate esters, sulfates, such as alcohol sulfates, alcohol ether sulfates and sulfated alkanolamide ethoxylates, sulfonates, such as sulfosuccinates, alkylbenzenesulfonates or alkylnaphthalenesulfonates.

Mention may be made, as nonionic surfactants, of acetylenic surfactants, alcohol ethoxylates, alkanolamides, amine oxides, ethoxylated alkanolamides, long-chain ethoxylated amines, ethylene oxide/propylene oxide copolymers, sorbitan derivatives, ethylene glycol, propylene glycol, glycerol, polyglyceryl esters and their ethoxylated derivatives, alkylamines, alkylimidazolines, ethoxylated oils and alkylphenol ethoxylates. Mention may in particular be made of the products sold under the brand names Igepal®, Dowanol®, Rhodamox® and Alkamide®.

As regards the carboxylic acids, use may in particular be made of aliphatic mono- or dicarboxylic acids and, among these, more particularly of saturated acids. Use may also be made of fatty acids and more particularly of saturated fatty acids. Mention may thus in particular be made of formic, acetic, propionic, butyric, isobutyric, valeric, caproic, caprylic, capric, lauric, myristic and palmitic acids. Mention may be made, as dicarboxylic acids, of oxalic, malonic, succinic, glutaric, adipic, pimelic, suberic, azelaic and sebacic acids.

The salts of the carboxylic acids can also be used.

Finally, it is possible to use a surfactant which is chosen from those of the carboxymethylated ethoxylates of fatty alcohols type.

The term “product of the carboxymethylated ethoxylates of fatty alcohols type” is understood to mean products composed of ethoxylated or propoxylated fatty alcohols comprising a CH₂—COOH group at the chain end.

These products can correspond to the formula:

R₁—O—(CR₂R₃—CR₄R₅—O)ₙ—CH₂—COOH

in which R₁ denotes a saturated or unsaturated carbon chain, the length of which is generally at most 22 carbon atoms, preferably at least 12 carbon atoms; R₂, R₃, R₄ and R₅ can be identical and represent hydrogen or alternatively R₂ can represent a CH₃ group and R₃, R₄ and R₅ represent hydrogen; n is a nonzero integer which can range up to 50 and more particularly of between 5 and 15, these values being inclusive. It should be noted that a surfactant can be composed of a mixture of products of the above formula for which R₁ can be saturated or unsaturated respectively or alternatively products comprising both —CH₂—CH₂—O— and —CH(CH₃)—CH₂—O— groups.

The surfactant can be added in two ways. It can be added directly to the precipitate suspension resulting from the preceding heating stage (c). It can also be added to the solid precipitate after separation of the latter by any known means from the medium in which the heating took place.

The amount of surfactant used, expressed as percentage by weight of additive with respect to the weight of the composition, calculated as oxide, is generally between 5% and 100%, more particularly between 15% and 60%.

It is possible to subject the suspended precipitate to moderate-energy milling by subjecting this suspension to shearing, for example using a colloid mill or a stirring turbine.

The compositions of the invention as described above or as obtained by the process mentioned above are provided in the form of powders but they can optionally be shaped in order to be provided in the form of granules, balls, cylinders or honeycombs of variable sizes. These compositions can be applied to any support commonly used in the field of catalysis, that is to say in particular thermally inert supports. This support can be chosen from alumina, titanium oxide, cerium oxide, zirconium oxide, silica, spinels, zeolites, silicates, crystalline silicoaluminum phosphates or crystalline aluminum phosphates.

The compositions can also be used in catalytic systems. These catalytic systems can comprise a coating (wash coat), based on these compositions and with catalytic properties, on a substrate of the metal or ceramic monolith type, for example. The coating can itself also comprise a support of the type of those mentioned above. This coating is obtained by mixing the composition with the support, so as to form a suspension which can subsequently be deposited on the substrate.

These catalytic systems and more particularly the compositions of the invention can have a great many applications. They are therefore particularly well suited to, and thus usable in, the catalysis of various reactions, such as, for example, dehydration, hydrosulfurization, hydrodenitrification, desulfurization, hydrodesulfurization, dehydrohalogenation, reforming, steam reforming, cracking, hydrocracking, hydrogenation, dehydrogenation, isomerization, dismutation, oxychlorination, dehydrocyclization of hydrocarbons or other organic compounds, oxidation and/or reduction reactions, the Claus reaction, treatment of exhaust gases from internal combustion engines, demetallation, methanation, the shift conversion, oxidation of CO, purification of air by low-temperature oxidation (<200° C., indeed even <100° C.), catalytic oxidation of the soot emitted by internal combustion engines, such as diesel engines or petrol engines operating under lean burn conditions.

In the case of these uses in catalysis, the compositions of the invention can be employed in combination with precious metals. The nature of these metals and the techniques for the incorporation of the latter in these compositions are well known to a person skilled in the art. For example, the metals can be platinum, rhodium, palladium, gold or iridium and they can, in particular, be incorporated in the compositions by impregnation.

Among the uses mentioned, the treatment of exhaust gases from internal combustion engines (automobile afterburning catalysis) is a particularly advantageous application. The compositions of the invention can thus be used in this case for three-way catalysis. More particularly still in the case of this use in three-way catalysis, the compositions can be employed in combination with an NOₓ (nitrogen oxides) trap for the treatment of exhaust gases from petrol engines operating with a lean burn mixture, for example in the three-way catalysis layer of such a trap. The compositions of the invention can be incorporated in oxidation catalysts for diesel engines.

For this reason, the invention also relates very particularly to a process for the treatment of exhaust gases from internal combustion engines which is characterized in that use is made, as catalyst, of a composition or of a catalytic system as described above.

Another advantageous use is the purification of air at temperatures of less than 200° C., indeed even of less than 100° C., this air comprising at least one compound of the carbon monoxide, ethylene, aldehyde, amine, mercaptan or ozone type and generally of the type of the volatile organic compounds or atmospheric pollutants, such as fatty acids, hydrocarbons, in particular aromatic hydrocarbons, and nitrogen oxides (for the oxidation of NO to give NO₂), and of the malodorous compounds type.

Mention may more particularly be made, as compounds of this type, of ethanethiol, valeric acid and trimethylamine. This treatment is carried out by bringing the air to be treated into contact with a composition or a catalytic system as described above or obtained by the processes described in detail above.

Concrete but nonlimiting examples will now be given.

In these examples, the ability to capture hydrogen is measured by temperature-programmed reduction in the following way. Use is made of a Micromeritics Autochem 2920 device with a quartz reactor and a 200 mg sample which has been calcined beforehand at 1000° C. for 10 hours under air. The gas is hydrogen at 10% by volume in argon and with a flow rate of 25 ml/min. The temperature rise takes place from ambient temperature to 900° C. at the rate of 20° C./min. The signal is detected with a thermal conductivity detector. The maximum reducibility temperature, which was mentioned above, is measured using a thermocouple placed at the heart of the sample.

The dynamic-OSC is measured using an Altamira FSR device. 30 mg of product, calcined beforehand at 1000° C. for 10 hours, are placed in a reactor, the temperature of which can be regulated at 300° C., 350° C., 400° C. or 450° C. Predetermined amounts of CO (5% in helium) and of O₂ (2.5% in helium) are alternately injected into this reactor at a frequency of 1 Hz and at a flow rate of 200 ml/min. The CO and O₂ contents are analyzed at the outlet of the reactor using a mass spectrometer.

The OSC is expressed in ml of O₂ (under standard temperature and pressure conditions) per gram of composition and per second from the formula:

OSC (ml·g⁻¹·s⁻¹)=[Δ(CO)×dCO]/[2×P]

in which Δ(CO) represents the amount of CO converted at each injection, dCO the CO flow rate and P the weight of the sample.

A first series of examples relates to compositions according to the first embodiment and a second series relates to compositions according to the second embodiment.

### EXAMPLE 1

This example relates to the preparation of a composition based on cerium, zirconium and tin oxides in the respective proportions by weight of oxide of 21.7%, 73.8% and 4.6%. 233 g of zirconium nitrate solution (270 g/l, expressed as oxide), 48 g of cerium(III) nitrate solution (496 g/l, expressed as oxide) and 7 g of tin(IV) chloride pentahydrate are introduced into a stirred beaker. The mixture is subsequently made up with distilled water so as to obtain 400 ml of a solution of the cerium, zirconium and tin salts.

145 ml of an aqueous ammonia solution (14.8 mol/l) and 49 ml of 30% aqueous hydrogen peroxide solution (9.8 mol/l) are introduced into a stirred reactor and the mixture is subsequently made up with distilled water so as to obtain a total volume of 400 ml.

The solution of the cerium, zirconium and tin salts is gradually introduced into the reactor with continual stirring.

The suspension thus obtained is filtered by centrifuging and then washed twice with 600 ml of distilled water. The precipitate is subsequently resuspended in 600 ml of aqueous solution at a pH of 10.

The solution obtained is placed in a stainless steel autoclave equipped with a stirrer. The temperature of the medium is brought to 150° C. for 2 hours with stirring.

The suspension obtained is filtered by centrifuging and then washed twice with 600 ml of distilled water.

The product obtained is subsequently dried in an oven at 110° C. overnight and finally calcined at 500° C. for 4 hours under stationary conditions.

The surfaces obtained after subsequent calcinations at different temperatures are shown below.

4 h 700° C.=76 m²/g

4 h 900° C.=42 m²/g

10 h 1000° C.=15 m²/g

### EXAMPLE 2

This example relates to the preparation of a composition based on cerium, zirconium and tin oxides in the respective proportions by weight of oxide of 42.6%, 53.1% and 4.3%.

167 g of zirconium nitrate solution (270 g/l, expressed as oxide), 95 g of cerium(III) nitrate solution (496 g/l, expressed as oxide) and 6.5 g of tin(IV) chloride pentahydrate are introduced into a stirred beaker. The mixture is subsequently made up with distilled water so as to obtain 400 ml of a solution of the cerium, zirconium and tin salts.

156 ml of an aqueous ammonia solution (14.8 mol/l) and 97 ml of 30% aqueous hydrogen peroxide solution (9.8 mol/l) are introduced into a stirred reactor and the mixture is subsequently made up with distilled water so as to obtain a total volume of 400 ml.

The operation is subsequently carried out as in example 1.

The surfaces obtained after subsequent calcinations at different temperatures are shown below.

4 h 700° C.=81 m²/g

4 h 900° C.=31 m²/g

10 h 1000° C.=9 m²/g

### EXAMPLE 3

This example relates to the preparation of a composition based on cerium, zirconium and tin oxides in the respective proportions by weight of oxide of 57.8%, 38.1% and 4.1%.

120 g of zirconium nitrate solution (270 g/l, expressed as oxide), 128 g of cerium(III) nitrate solution (496 g/l, expressed as oxide) and 6.2 g of tin(IV) chloride pentahydrate are introduced into a stirred beaker. The mixture is subsequently made up with distilled water so as to obtain 400 ml of a solution of the cerium, zirconium and tin salts.

164 ml of an aqueous ammonia solution (14.8 mol/l) and 132 ml of 30% aqueous hydrogen peroxide solution (9.8 mol/l) are introduced into a stirred reactor and the mixture is subsequently made up with distilled water so as to obtain a total volume of 400 ml.

The operation is subsequently carried out as in example 1.

The surfaces obtained after subsequent calcinations at different temperatures are shown below.

4 h 700° C.=77 m²/g

4 h 900° C.=33 m²/g

10 h 1000° C.=6 m²/g

### COMPARATIVE EXAMPLE 4

This example relates to the preparation of a composition based on cerium and zirconium oxides in the respective proportions by weight of oxide of 20% and 80%.

252 g of zirconium nitrate solution (270 g/l, expressed as oxide) and 44 g of cerium(III) nitrate solution (496 g/l, expressed as oxide) are introduced into a stirred beaker. The mixture is subsequently made up with distilled water so as to obtain 400 ml of a solution of the cerium, zirconium and tin salts.

137 ml of an aqueous ammonia solution (14.8 mol/l) and 45 ml of 30% aqueous hydrogen peroxide solution (9.8 mol/l) are introduced into a stirred reactor and the mixture is subsequently made up with distilled water so as to obtain a total volume of 400 ml.

The operation is subsequently carried out as in example 1.

The surfaces obtained after subsequent calcinations at different temperatures are shown below.

4 h 700° C.=72 m²/g

4 h 900° C.=36 m²/g

10 h 1000° C.=7 m²/g

The various characteristics of the compositions obtained after calcination at 1000° C. for 10 hours are given in table 1 below.

In this table, the number or numbers in the “TPR<500° C.” column shows the temperature at which the presence of one or of two reducibility peaks is detected during the measurement of the ability to capture hydrogen. The absence of a value in this column means that such a peak was not detected at a temperature of less than 500° C. The “TPR max” column shows the temperature at which the maximum reducibility peak was detected.

The “OSC” column gives the value of the oxygen storage capacity measured at 400° C. according to the method given above.

TABLE 1

| | BET surface | TPR | | OSC at 400° C. |
|---|---|---|---|---|
| Example | (m²/g) | <500° C. | max | (ml · g⁻¹ · s⁻¹⁾ |
| 1 | 15 | 220/430 | 610 | 0.45 |
| 2 | 9 | 230/430 | 600 | 1.25 |
| 3 | 6 | 240/360 | 585 | 0.95 |
| 4, comparative | 7 | — | 625 | 0.05 |

Compositions 2 and 3 exhibit an OSC at 300° C. of 0.26 and 0.11 ml·g⁻¹·s⁻¹ respectively.

The examples which follow relate to compositions according to the second embodiment.

### EXAMPLE 5

This example relates to the preparation of a composition based on cerium, zirconium, tin and lanthanum oxides in the respective proportions by weight of oxide of 21.4%, 69.4%, 4.4% and 4.8%.

219 g of zirconium nitrate solution (270 g/l, expressed as oxide), 48 g of cerium(III) nitrate solution (496 g/l, expressed as oxide), 11 g of lanthanum nitrate (450 g/l, expressed as oxide) and 6.7 g of tin(IV) chloride pentahydrate are introduced into a stirred beaker. The mixture is subsequently made up with distilled water so as to obtain 400 ml of a solution of the cerium, zirconium, lanthanum and tin salts.

138.5 ml of an aqueous ammonia solution (14.8 mol/l) and 49 ml of 30% aqueous hydrogen peroxide solution (9.8 mol/l) are introduced into a stirred reactor and the mixture is subsequently made up with distilled water so as to obtain a total volume of 400 ml.

The solution of the cerium, zirconium and tin salts is gradually introduced into the reactor with continual stirring.

The suspension thus obtained is filtered by centrifuging and then washed twice with 600 ml of distilled water. The precipitate is subsequently resuspended in 600 ml of aqueous solution at a pH of 10.

The solution obtained is placed in a stainless steel autoclave equipped with a stirrer. The temperature of the medium is brought to 150° C. for 2 hours with stirring.

The suspension obtained is filtered by centrifuging and then washed twice with 600 ml of distilled water.

The product obtained is subsequently dried in an oven at 110° C. overnight and finally calcined at 500° C. for 4 hours under stationary conditions.

The surfaces obtained after subsequent calcinations at different temperatures are shown below.

4 h 700° C.=103 m²/g

4 h 900° C.=62 m²/g

10 h 1000° C.=30 m²/g

10 h 1100° C.=11 m²/g

### EXAMPLE 6

This example relates to the preparation of the composition of example 5 according to the alternative form of the process using a surfactant.

The operation is carried out in the same way as in example 5 up to the washing twice with 600 ml of distilled water of the precipitate resulting from the filtration by centrifuging of the suspension obtained after the treatment in the autoclave at 150° C. 50 g of this precipitate are withdrawn.

At the same time, an ammonium laurate gel was prepared under the following conditions: 125 g of lauric acid are introduced into 68 ml of aqueous ammonia solution (12 mol/l) and 250 ml of distilled water and then the mixture is homogenized using a spatula.

15 g of this gel are added to the 50 g of the precipitate and then the combined mixture is kneaded until a homogeneous paste is obtained.

The product obtained is subsequently calcined at 500° C. for 4 hours under stationary conditions.

The surfaces obtained after subsequent calcinations at different temperatures are shown below.

4 h 900° C.=73 m²/g

10 h 1000° C.=45 m²/g

10 h 1100° C.=13 m²/g

### EXAMPLE 7

This example relates to the preparation of a composition based on cerium, zirconium, tin and neodymium oxides in the respective proportions by weight of oxide of 21.4%, 69.3%, 4.4% and 4.9%.

218 g of zirconium nitrate solution (270 g/l, expressed as oxide), 47 g of cerium(III) nitrate solution (496 g/l, expressed as oxide), 11 g of neodymium nitrate solution (524 g/l, expressed as oxide) and 6.7 g of tin(IV) chloride pentahydrate are introduced into a stirred beaker. The mixture is subsequently made up with distilled water so as to obtain 400 ml of a solution of the cerium, zirconium, lanthanum and tin salts.

147.5 ml of an aqueous ammonia solution (14.8 mol/l) and 49 ml of 30% aqueous hydrogen peroxide solution (9.8 mol/l) are introduced into a stirred reactor and the mixture is subsequently made up with distilled water so as to obtain a total volume of 400 ml.

The operation is subsequently carried out as in example 5.

The surfaces obtained after subsequent calcinations at different temperatures are shown below.

4 h 700° C.=95 m²/g

4 h 900° C.=55 m²/g

10 h 1000° C.=24 m²/g

10 h 1100° C.=6 m²/g

### EXAMPLE 8

This example relates to the preparation of a composition based on cerium, zirconium, tin and yttrium oxides in the respective proportions by weight of oxide of 21.7%, 70.4%, 4.5% and 3.4%.

222 g of zirconium nitrate solution (270 g/l, expressed as oxide), 48 g of cerium(III) nitrate solution (496 g/l, expressed as oxide), 10 g of yttrium nitrate solution (354 g/l, expressed as oxide) and 6.8 g of tin(IV) chloride pentahydrate are introduced into a stirred beaker. The mixture is subsequently made up with distilled water so as to obtain 400 ml of a solution of the cerium, zirconium, lanthanum and tin salts.

150 ml of an aqueous ammonia solution (14.8 mol/l) and 49.5 ml of 30% aqueous hydrogen peroxide solution (9.8 mol/l) are introduced into a stirred reactor and the mixture is subsequently made up with distilled water so as to obtain a total volume of 400 ml.

The operation is subsequently carried out as in example 5.

The surfaces obtained after subsequent calcinations at different temperatures are shown below.

4 h 700° C.=90 m²/g

4 h 900° C.=44 m²/g

10 h 1000° C.=15 m²/g

10 h 1100° C.=1.5 m²/g

### EXAMPLE 9

This example relates to the preparation of a composition based on cerium, zirconium, tin and lanthanum oxides in the respective proportions by weight of oxide of 41.4%, 50.0%, 4.1% and 4.5%.

158 g of zirconium nitrate solution (270 g/l, expressed as oxide), 92 g of cerium(III) nitrate solution (496 g/l, expressed as oxide), 11 g of lanthanum nitrate solution (450 g/l, expressed as oxide) and 6.2 g of tin(IV) chloride pentahydrate are introduced into a stirred beaker. The mixture is subsequently made up with distilled water so as to obtain 400 ml of a solution of the cerium, zirconium, lanthanum and tin salts.

158 ml of an aqueous ammonia solution (14.8 mol/l) and 94 ml of 30% aqueous hydrogen peroxide solution (9.8 mol/l) are introduced into a stirred reactor and the mixture is subsequently made up with distilled water so as to obtain a total volume of 400 ml.

The operation is subsequently carried out as in example 5.

The surfaces obtained after subsequent calcinations at different temperatures are shown below.

4 h 700° C.=91 m²/g

4 h 900° C.=44 m²/g

10 h 1000° C.=22 m²/g

10 h 1100° C.=4.5 m²/g

### EXAMPLE 10

This example relates to the preparation of a composition based on cerium, zirconium, tin and lanthanum oxides in the respective proportions by weight of oxide of 56.3%, 35.5%, 3.9% and 4.3%.

112 g of zirconium nitrate solution (270 g/l, expressed as oxide), 125 g of cerium(III) nitrate solution (496 g/l, expressed as oxide), 10 g of lanthanum nitrate solution (450 g/l, expressed as oxide) and 6 g of tin(IV) chloride pentahydrate are introduced into a stirred beaker. The mixture is subsequently made up with distilled water so as to obtain 400 ml of a solution of the cerium, zirconium, lanthanum and tin salts.

166 ml of an aqueous ammonia solution (14.8 mol/l) and 128 ml of 30% aqueous hydrogen peroxide solution (9.8 mol/l) are introduced into a stirred reactor and the mixture is subsequently made up with distilled water so as to obtain a total volume of 400 ml.

### EXAMPLE 11

This example relates to the preparation of a composition based on cerium, zirconium, tin and lanthanum oxides in the respective proportions by weight of oxide of 69.8%, 22.3%, 3.8% and 4.1%.

70 g of zirconium nitrate solution (270 g/l, expressed as oxide), 155 g of cerium(III) nitrate solution (496 g/l, expressed as oxide), 10 g of lanthanum nitrate solution (450 g/l, expressed as oxide) and 5.8 g of tin(IV) chloride pentahydrate are introduced into a stirred beaker. The mixture is subsequently made up with distilled water so as to obtain 400 ml of a solution of the cerium, zirconium, lanthanum and tin salts.

173 ml of an aqueous ammonia solution (14.8 mol/l) and 159 ml of 30% aqueous hydrogen peroxide solution (9.8 mol/l) are introduced into a stirred reactor and the mixture is subsequently made up with distilled water so as to obtain a total volume of 400 ml.

The operation is subsequently carried out as in example 5.

The surfaces obtained after subsequent calcinations at different temperatures are shown below.

4 h 700° C.=82 m²/g

4 h 900° C.=36 m²/g

10 h 1000° C.=15 m²/g

10 h 1100° C.=4.5 m²/g

### EXAMPLE 12

This example relates to the preparation of a composition based on cerium, zirconium, tin and lanthanum oxides in the respective proportions by weight of oxide of 21.2%, 65.3%, 8.8% and 4.7%.

206 g of zirconium nitrate solution (270 g/l, expressed as oxide), 47 g of cerium(III) nitrate solution (496 g/l, expressed as oxide), 11 g of lanthanum nitrate solution (450 g/l, expressed as oxide) and 13.4 g of tin(IV) chloride pentahydrate are introduced into a stirred beaker. The mixture is subsequently made up with distilled water so as to obtain 400 ml of a solution of the cerium, zirconium, lanthanum and tin salts.

154 ml of an aqueous ammonia solution (14.8 mol/l) and 48 ml of 30% aqueous hydrogen peroxide solution (9.8 mol/l) are introduced into a stirred reactor and the mixture is subsequently made up with distilled water so as to obtain a total volume of 400 ml.

The operation is subsequently carried out as in example 5.

The surfaces obtained after subsequent calcinations at different temperatures are shown below.

4 h 700° C.=100 m²/g

4 h 900° C.=60 m²/g

10 h 1000° C.=29 m²/g

10 h 1100° C.=8 m²/g

### EXAMPLE 13

This example relates to the preparation of a composition based on cerium, zirconium, tin and praseodymium oxides in the respective proportions by weight of oxide of 21.1%, 69.5%, 4.3% and 5.1%.

216 g of zirconium nitrate solution (299 g/l, expressed as oxide), 76 g of cerium(IV) nitrate solution (255 g/l, expressed as oxide), 11 g of praseodymium nitrate (543 g/l, expressed as oxide) and 6.5 g of tin(IV) chloride pentahydrate are introduced into a stirred beaker. The mixture is subsequently made up with distilled water so as to obtain 400 ml of a solution of the cerium, zirconium, praseodymium and tin salts.

109 ml of an aqueous ammonia solution (14.8 mol/l) are introduced into a stirred reactor and the mixture is subsequently made up with distilled water so as to obtain a total volume of 400 ml.

The solution of the cerium, zirconium, praseodymium and tin salts is gradually introduced into the reactor with continual stirring.

The suspension thus obtained is filtered by vacuum filtration and then washed twice with 600 ml of distilled water. The precipitate is subsequently resuspended in 600 ml of aqueous solution at a pH of 10.

The solution obtained is placed in a stainless steel autoclave equipped with a stirrer. The temperature of the medium is brought to 150° C. for 2 hours with stirring.

The suspension obtained is filtered by vacuum filtration and then washed twice with 600 ml of distilled water.

The product obtained is subsequently dried in an oven at 110° C. overnight and finally calcined at 500° C. for 4 hours under stationary conditions.

The surfaces obtained after subsequent calcinations at different temperatures are shown below.

4 h 700° C.=92 m²/g

4 h 900° C.=60 m²/g

10 h 1000° C.=34 m²/g

10 h 1100° C.=11 m²/g

### EXAMPLE 14

This example relates to the preparation of a composition based on cerium, zirconium, tin and lanthanum oxides in the respective proportions by weight of oxide of 21.5%, 72.6%, 1.1% and 4.8%. This is a composition with a low tin content.

225 g of zirconium nitrate solution (299 g/l, expressed as oxide), 77 g of cerium(IV) nitrate solution (255 g/l, expressed as oxide), 11 g of lanthanum nitrate (450 g/l, expressed as oxide) and 1.7 g of tin(IV) chloride pentahydrate are introduced into a stirred beaker. The mixture is subsequently made up with distilled water so as to obtain 400 ml of a solution of the cerium, zirconium, lanthanum and tin salts.

111 ml of an aqueous ammonia solution (14.8 mol/l) are introduced into a stirred reactor and the mixture is subsequently made up with distilled water so as to obtain a total volume of 400 ml.

The operation is subsequently carried out as in example 13.

The surfaces obtained after subsequent calcinations at different temperatures are shown below.

4 h 700° C.=95 m²/g

4 h 900° C.=65 m²/g

10 h 1000° C.=40 m²/g

10 h 1100° C.=15 m²/g

### EXAMPLE 15

This example relates to the preparation of the composition of example 5 according to an alternative form of the process using a surfactant and a cerium(IV) nitrate solution.

215 g of zirconium nitrate solution (299 g/l, expressed as oxide), 77 g of cerium(IV) nitrate solution (255 g/l, expressed as oxide), 11 g of lanthanum nitrate (450 g/l, expressed as oxide) and 6.7 g of tin(IV) chloride pentahydrate are introduced into a stirred beaker. The mixture is subsequently made up with distilled water so as to obtain 400 ml of a solution of the cerium, zirconium, lanthanum and tin salts.

113 ml of an aqueous ammonia solution (14.8 mol/l) are introduced into a stirred reactor and the mixture is subsequently made up with distilled water so as to obtain a total volume of 400 ml.

The solution of the cerium, zirconium, lanthanum and tin salts is gradually introduced into the reactor with continual stirring.

The suspension thus obtained is filtered by vacuum filtration and then washed twice with 600 ml of distilled water. The precipitate is subsequently resuspended in 600 ml of aqueous solution at a pH of 10.

The solution obtained is placed in a stainless steel autoclave equipped with a stirrer. The temperature of the medium is brought to 150° C. for 2 hours with stirring.

The suspension obtained is filtered by vacuum filtration and then washed twice with 600 ml of distilled water.

50 g of the filtration cake are withdrawn.

At the same time, an ammonium laurate gel was prepared under the following conditions: 125 g of lauric acid are introduced into 68 ml of aqueous ammonia solution (12 mol/l) and 250 ml of distilled water and then the mixture is homogenized using a spatula.

15 g of this gel are added to the 50 g of the precipitate and then the combined mixture is kneaded until a homogeneous paste is obtained.

The product obtained is subsequently dried in an oven at 110° C. overnight and finally calcined at 500° C. for 4 hours under stationary conditions.

The surfaces obtained after subsequent calcinations at different temperatures are shown below.

4 h 700° C.=94 m²/g

4 h 900° C.=67 m²/g

10 h 1000° C.=44 m²/g

10 h 1100° C.=20 m²/g

10 h 1200° C.=4 m²/g

The content of chlorides in this composition after calcination at 500° C. is less than 30 ppm.

### EXAMPLE 16

This example relates to the preparation of the composition of example 5 according to an alternative form of the process using a surfactant and stannous oxalate as tin precursor.

215.5 g of zirconium nitrate solution (299 g/l, expressed as oxide), 77 g of cerium(IV) nitrate solution (255 g/l, expressed as oxide), 11.5 g of lanthanum nitrate (450 g/l, expressed as oxide) and 3.9 g of stannous oxalate tin(IV) chloride pentahydrate are introduced into a stirred beaker. The mixture is subsequently made up with distilled water so as to obtain 400 ml of a solution of the cerium, zirconium, lanthanum and tin salts.

109 ml of an aqueous ammonia solution (14.8 mol/l) and 20 ml of 30% aqueous hydrogen peroxide solution (9.8 mol/l) are introduced into a stirred reactor and the mixture is subsequently made up with distilled water so as to obtain a total volume of 400 ml.

The operation is subsequently carried out as in example 15, except that just one volume of water is used during the washing operations.

The surfaces obtained after subsequent calcinations at different temperatures are shown below.

4 h 700° C.=100 m²/g

4 h 900° C.=67 m²/g

10 h 1000° C.=44 m²/g

10 h 1100° C.=18 m²/g

The various characteristics of the compositions obtained are given in table 2 below.

TABLE 2

| | BET | | | | | |
|---|---|---|---|---|---|---|
| | surface* | | TPR | | OSC (ml · g⁻¹ · s⁻¹) | |
| Example | (m²/g) | | <500° C. | Max | 300° C. | 400° C. |
| 5 | 30 | (11) | 350 | 350 | 0.55 | 2.10 |
| 6 | 45 | (13) | 330 | 330 | 0.30 | 1.20 |
| 7 | 24 | (6) | 375 | 375 | 0.65 | 1.98 |
| 8 | 15 | (1.5) | 405 | 590 | 0.05 | 0.36 |
| 9 | 22 | (6) | 370 | 370 | 0.25 | 1.23 |
| 10 | 15 | (4.5) | 355 | 355 | 0.40 | 1.40 |
| 11 | 15 | (6) | 315 | 315 | 0.60 | 1.85 |
| 12 | 29 | (8) | 315 | 315 | 0.80 | 2.15 |
| 13 | 34 | (11) | 330 | 330 | 0.55 | 2.15 |
| 14 | 40 | (15) | 390 | 390 | 0.15 | 0.90 |
| 15 | 44 | (20) | 330 | 330 | 1.05 | 2.60 |
| 16 | 44 | (18) | 340 | 340 | 0.75 | 2.10 |

*The values in brackets in this column are the surface values after calcination at 1100° C. for 10 hours.

1-22. (canceled)

23. A composition based on zirconium oxide and cerium oxide, comprising tin oxide in a proportion of at most 25%, optionally, of at most 20% by weight of oxide.

24. The composition as claimed in claim 23, wherein the tin oxide proportion is of at most 10%, by weight of oxide, optionally of at most 5% by weight of oxide.

25. The composition as claimed in claim 23, having a Ce/Zr molar ratio of between 0.10 and 4, optionally between 0.15 and 2.25.

26. The composition as claimed in claim 23, further comprising at least one oxide of a rare earth metal other than cerium.

27. The composition as claimed in claim 26, having a proportion of the oxide of the abovementioned rare earth metal of at most 35%, optionally at most 10%.

28. The composition as claimed in claim 26, wherein the above-mentioned rare earth metal is yttrium, lanthanum, neodymium or praseodymium.

29. The composition as claimed in claim 23, exhibiting at least one reducibility peak at a temperature of less than 500° C.

30. The composition as claimed in claim 23, exhibiting an OSC of at least 0.3 ml of O₂/g/s at 400° C.

31. The composition as claimed in claim 30, wherein the OSC is of at least 0.35 ml of O₂/g/s, optionally of at least 1 ml of O₂/g/s, at 400° C.

32. The composition as claimed in claim 23, having a Ce/Zr ratio of at least 0.5 and an OSC of at least 0.1 ml of O₂/g/s at 300° C.

33. The composition as claimed in claim 26, exhibiting an OSC of at least 0.2 ml of O₂/g/s, optionally of at least 0.4 ml of O₂/g/s, at 300° C.

34. The composition as claimed in claim 25, exhibiting either a Ce/Zr ratio of at least 1 and a specific surface, after calcination at 1000° C. for 10 hours, of at least 5 m²/g or a Ce/Zr ratio of less than 1 and a specific surface, after calcination at 1000° C. for 10 hours, of at least 8 m²/g.

35. The composition as claimed in claim 34, exhibiting either a Ce/Zr ratio of at least 1 and a specific surface, after calcination at 1000° C. for 10 hours, of at least 5 m²/g or a Ce/Zr ratio of less than 1 and a specific surface, after calcination at 1000° C. for 10 hours, of at least 15 m²/g.

36. A process for the preparation of a composition as defined in claim 23 comprising the following stages:
(a) forming a mixture comprising compounds of zirconium, of cerium, and of tin;
(b) bringing said mixture into contact with a basic compound, to obtain a precipitate;
(c) heating the precipitate obtained in stage (b) in an aqueous medium;
(d) calcinating the precipitate obtained in stage (c).

37. A process for the preparation of a composition as defined in claim 26 comprising the following stages:
(a) forming a mixture comprising compounds of zirconium, of cerium, of tin and, of the abovementioned rare earth metal;
(b) bringing said mixture into contact with a basic compound, to obtain a precipitate;
(c) heating the precipitate obtained in stage (b) in an aqueous medium;
(d) calcinating the precipitate obtained in stage (c).

38. The process as claimed in claim 36, further comprising an additional stage (cd), intermediate between the abovementioned stage (c) and the above-mentioned calcination stage (d), wherein a surfactant additive selected from the group consisting of anionic surfactants, nonionic surfactants, polyethylene glycols, and carboxylic acids, salts of carboxylic acids and carboxymethylated ethoxylates of fatty alcohols, is added to the precipitate obtained in stage (c).

39. The process as claimed in claim 36, wherein in stage (a) the compounds of zirconium, cerium, and tin are nitrates, acetates, oxalates, chlorides or ceric ammonium nitrates.

40. The process as claimed in claim 36, wherein, in stage (a), the cerium compound is in the form of Ce(III) and/or of a tin(II) compound and an oxidizing agent is added during stage (a) or during stage (b), optionally at the end of the latter.

41. The process as claimed in claim 36, wherein the heating of the precipitate of stage (c) is carried out at a temperature of at least 100° C.

42. A catalytic system, comprising a composition as defined in claim 23.

43. A process for the treatment of exhaust gases from internal combustion

43. A process for the treatment of exhaust gases from internal combustion engines, comprising the step of bringing into contact said gases with the catalytic system as claimed in claim 42.

44. A process for the purification of air, said air comprising carbon monoxide, ethylene, aldehyde, amine, mercaptan, ozone, volatile organic compounds, atmospheric pollutants, fatty acids, hydrocarbons, aromatic hydrocarbons, nitrogen oxides or malodorous compounds, comprising the step of bringing into contact said gases with the catalytic system as claimed in claim 42.
